(19) United States
(12) Patent Application Publication
(10) Pub. No.: US 2023/0135814 A1
(43) Pub. Date: May 4, 2023

(54) METHOD FOR DISTRIBUTING CRYPTOGRAPHICALLY SECURED DIGITAL ASSETS ON AN ONLINE MARKETPLACE

(71) Applicant: Ultimax Digital, Inc., New York, NY (US)

(72) Inventor: Paul GOODMAN, New York, NY (US)

(73) Assignee: Ultimax Digital, Inc., New York, NY (US)

(21) Appl. No.: 17/980,806

(22) Filed: Nov. 4, 2022

Related U.S. Application Data
(60) Provisional application No. 63/263,554, filed on Nov. 4, 2021.

(51) Int. Cl. G06Q 30/06; G06Q 30/00

(52) U.S. Cl. CPC G06Q 30/0621; G06Q 30/0185; G06Q 2220/00

(57) ABSTRACT

A method for creation of a cryptographically secured digital asset is disclosed. The method includes providing an application which allows a user to capture graphical data of electronic gameplay to create a cryptographically secured digital asset. A method of distributing such cryptographically secured digital assets using a voting process and rating system is also disclosed.

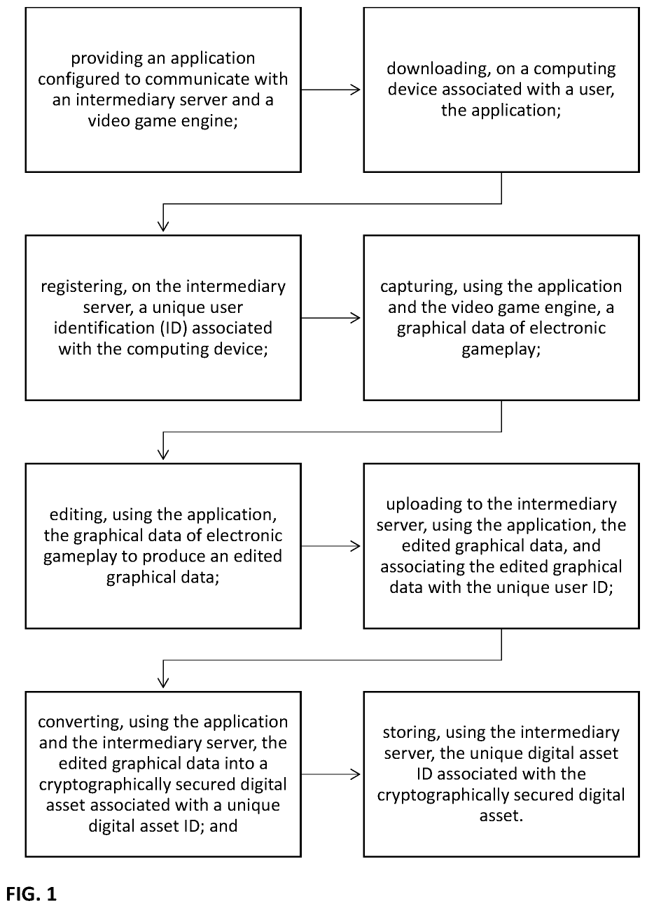

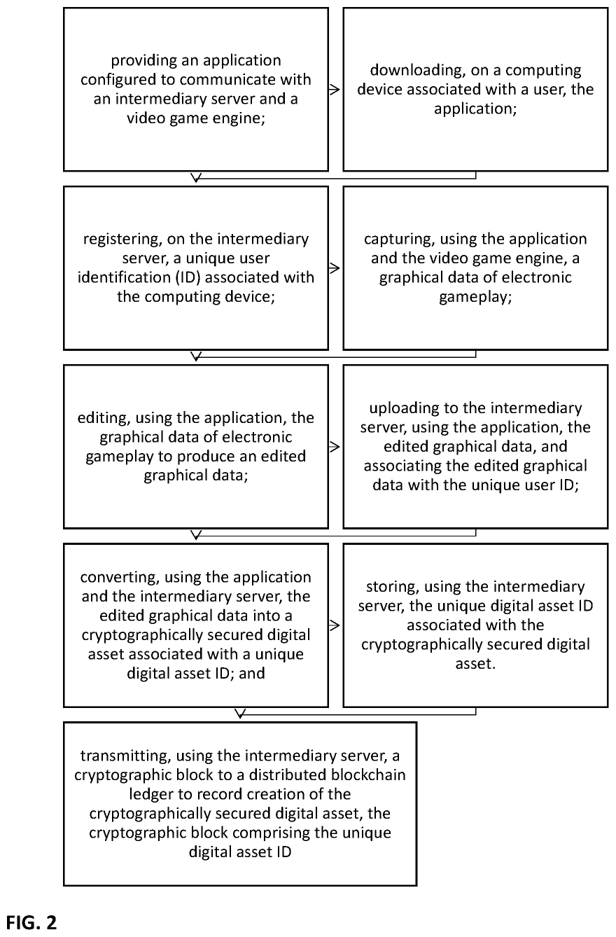

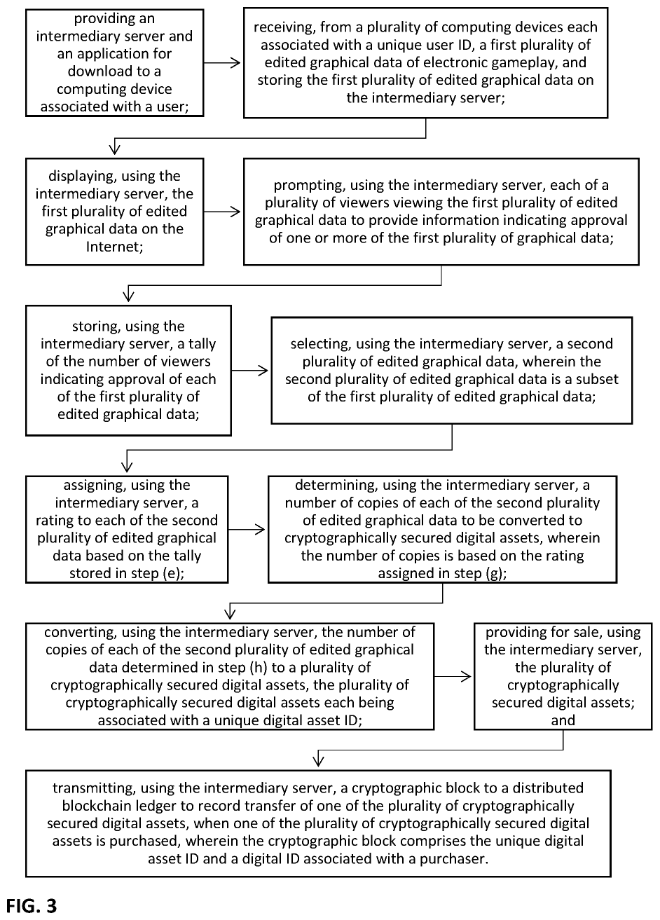

### CLAIM OF PRIORITY

This application claims priority to United States Provisional Patent Application No. 63/263,554, filed Nov. 4, 2021, entitled “Method for Distributing Cryptographically Secured Digital Assets on an Online Marketplace”, the contents of which are hereby incorporated by reference in their entirety.

### NOTICE OF COPYRIGHTS AND TRADE DRESS

A portion of the disclosure of this patent document contains material which is subject to copyright or trade dress protection. This patent document may show and/or describe matter that is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### FIELD OF THE EMBODIMENTS

The present disclosure relates generally to a method for distribution of cryptographically secured digital assets on an online marketplace. More particularly, the present disclosure relates to a method for distribution of cryptographically secured digital assets on an online marketplace that have been made by users from graphical data captured from electronic gameplay.

### BACKGROUND

Electronic games are an increasingly large segment of the entertainment market. In 2020 alone, revenues from electronic games approached $180 billion dollars. As a result, players of electronic games have created an influential sub-culture involving fandom of their favorite games, game franchises, game companies, and especially, particular game characters. Such fandom has manifested in such forms as fan art, cosplay, fan-made videos, and many other forms.

The most ardent fans often spend a substantial amount of money collecting collectible items associated with their favorite aspects of gaming culture. Thus, given the increasing size of the electronic gaming market, there is a corresponding, and ever-increasing demand for such collectible gaming items.

Given such demand, there is a desire from both gaming companies to share in the profits of such market for collectible items, and from electronic gaming fans themselves, to be empowered to create fan media in collectible form for distribution to fellow fans.

### SUMMARY OF THE INVENTION

The present disclosure provides for a method of creation of a cryptographically secured digital asset, the method including the steps of providing an application configured to communicate with an intermediary server and a video game engine, downloading, on a computing device associated with a user, the application, registering, on the intermediary server, a unique user identification (ID) associated with the computing device, capturing, using the application and the video game engine, a graphical data of electronic gameplay, editing, using the application, the graphical data of electronic gameplay to produce an edited graphical data, uploading to the intermediary server, using the application, the edited graphical data, and associating the edited graphical data with the unique user ID, converting, using the application and the intermediary server, the edited graphical data into a cryptographically secured digital asset associated with a unique digital asset ID, and storing, using the intermediary server, the unique digital asset ID associated with the cryptographically secured digital asset.

In an embodiment, the method further includes transmitting, using the intermediary server, a cryptographic block to a distributed blockchain ledger to record creation of the cryptographically secured digital asset, the cryptographic block including the unique digital asset ID.

The present disclosure also provides for a method of distribution of a cryptographically secured digital asset, the method including the steps of providing an intermediary server and an application for download to a computing device associated with a user, receiving, from a plurality of computing devices each associated with a unique user ID, a first plurality of edited graphical data of electronic gameplay, and storing the first plurality of edited graphical data on the intermediary server, displaying, using the intermediary server, the first plurality of edited graphical data on the Internet, prompting, using the intermediary server, each of a plurality of viewers viewing the first plurality of edited graphical data to provide information indicating approval of one or more of the first plurality of graphical data, storing, using the intermediary server, a tally of the number of viewers indicating approval of each of the first plurality of edited graphical data, selecting, using the intermediary server, a second plurality of edited graphical data, wherein the second plurality of edited graphical data is a subset of the first plurality of edited graphical data, assigning, using the intermediary server, a rating to each of the second plurality of edited graphical data based on the tally previously stored, determining, using the intermediary server, a number of copies of each of the second plurality of edited graphical data to be converted to cryptographically secured digital assets, wherein the number of copies is based on the rating previously assigned, converting, using the intermediary server, the number of copies of each of the second plurality of edited graphical data previously determined to a plurality of cryptographically secured digital assets, the plurality of cryptographically secured digital assets each being associated with a unique digital asset ID, providing for sale, using the intermediary server, the plurality of cryptographically secured digital assets, and transmitting, using the intermediary server, a cryptographic block to a distributed blockchain ledger to record transfer of one of the plurality of cryptographically secured digital assets, when one of the plurality of cryptographically secured digital assets is purchased, wherein the cryptographic block comprises the unique digital asset ID and a digital ID associated with a purchaser.

In an embodiment, the method further includes transmitting, for each of the plurality of cryptographically secured digital assets, using the intermediary server, a cryptographic block to a distributed blockchain ledger to record creation of a cryptographically secured asset, wherein the cryptographic block comprises the unique digital asset ID and a digital ID associated with the intermediary server.

In an embodiment, the cryptographic block further includes a set of instructions, wherein the set of instructions defines at least one condition and at least one action to be performed on evaluation of the at least one condition.

In an embodiment, the at least one condition includes a resale of the cryptographically secured digital asset associated with the unique digital asset ID recorded in the cryptographic block, and the at least one action includes remitting 10% of a resale price of the cryptographically secured digital asset associated with the unique digital asset ID recorded in the cryptographic block to the intermediary server.

The present disclosure also provides for a non-transitory computer readable storage medium, including storage, retrieval, modification, and linking system software which instructs at least one computer processor residing on a specialized computer system to implement a process of creation of a cryptographically secured digital asset. In some embodiments, the non-transitory computer readable storage medium instructs at least one computer processor residing on a specialized computer system to implement a process to: download an application configured to communicate with an intermediary server and a video game engine; register, on the intermediary server, a unique user identification (ID) associated with the specialized computer system; capture, using the application and the video game engine, a graphical data of electronic gameplay; edit, using the application, the graphical data of electronic gameplay to produce an edited graphical data; upload to the intermediary server, using the application, the edited graphical data, and associate the edited graphical data with the unique user ID; convert, using the application and the intermediary server, the edited graphical data into a cryptographically secured digital asset associated with a unique digital asset ID; and store, using the intermediary server, the unique digital asset ID associated with the cryptographically secured digital asset.

The claims should not necessarily be construed as limited to addressing any of the particular problems or deficiencies discussed hereinabove. To the accomplishment of the above, this disclosure may be embodied in the form illustrated in the accompanying drawings. Attention is called to the fact, however, that the drawings are illustrative only. Variations are contemplated as being part of the disclosure.

Implementations may include one or a combination of any two or more of the aforementioned features or embodiments.

These and other aspects, features, implementations, and advantages can be expressed as methods, apparatuses, systems, components, program products, business methods, and means or steps for performing functions, or some combination thereof.

Other features, aspects, implementations, and advantages will become apparent from the descriptions, the drawings, and the claims.

### DETAILED DESCRIPTION OF THE PREFERRED EMBODIMENTS

Reference will now be made in detail to each embodiment of the present invention. Such embodiments are provided by way of explanation of the present invention, which is not intended to be limited thereto in any manner whatsoever. In fact, those of ordinary skill in the art may appreciate upon reading the present specification and viewing the present drawings that various modifications and variations can be made thereto.

For purposes of the present disclosure of the invention, unless specifically disclaimed, the singular includes the plural and vice-versa, the words “and” and “or” shall be both conjunctive and disjunctive, the words “any” and “all” shall both mean “any and all”.

An embodiment of the present invention provides a method of a cryptographically secured digital asset, including a step of providing an application configured to communicate with an intermediary server and a video game engine. Preferably, the video game engine includes the most popular video game developments platforms, such as, but not limited to, the Unity® game engine and the Unreal® Engine. However, any video game engine may be used in conjunction with the application of the present invention. In some embodiments, the application is provided as a software plug-in or software development kit (“SDK”), preferably with separate versions designed for each video game engine. In other embodiments, the application is designed as a single version compatible with all contemplated video game engines. In some embodiments, the application is designed to integrate with existing electronic games. In some embodiments, the application is designed to integrate with new electronic games, or future, yet to be created, electronic games.

In some embodiments, the method of the present invention includes a step of downloading, on a computing device associated with a user, the application. In some embodiments, the computing device may be a personal computer, tablet device, mobile device, console gaming system, or any other device capable of playing electronic games. Preferably, the application is directly downloaded through the Internet from a server associated with the present method. However, any method of transferring the data comprising the application to the computing device may be used, such as, but not limited to, transfer through third-party servers, transfer through peer-to-peer networks, transfer through email, transfer through physical media such as USB drives, or DVDs, and any other methods as would be understood by a person of ordinary skill in the art. In some embodiments, the application may be pre-installed on a computing device.

In some embodiments, the method of the present invention includes a step of registering, on the intermediary server, a unique user identification (“ID”) associated with the computing device. In some embodiments, the unique user ID is derived from information provided by the user. In some embodiments, the registering may comprise commonly used sub-steps known in the art for digital registration, such as prompting the user for a unique username and password, prompting the user for an email address, verifying an age or identification of the user, and others. In some embodiments, the step of registering may also include prompting the user to link their account to an existing account created with one or more services, such as Facebook, Google, or Apple. In some embodiments, the registering may prompt the user to link their registration to such an existing account in lieu of other registration information.

In some embodiments, the method of the present invention includes a step of capturing, using the application and the video game engine, a graphical data of electronic gameplay. Preferably, the graphical data is graphical data of an electronic gaming character, more preferably of an avatar representing the user. However, the graphical data can be graphical data of any aspect of electronic gameplay. Further, the graphical data can also be placed within a pre-planned digital frame to give the appearance of being similar to a trading card.

In some embodiments, the method of the present invention includes a step of editing, using the application, the graphical data of electronic gameplay to produce an edited graphical data. In some embodiments, the editing may include, but is limited to, editing the appearance of the graphical data, editing the background of the graphical data, rotating the perspective of the graphical data, zooming in on a particular aspect of the graphical data, and others. Preferably, the editing includes placing the graphical data into a pre-designed digital frame. Preferably, the editing includes adding a displaying a digital signature, such as that of the user, on top of the graphical data. In some embodiments, the editing may involve first uploading the graphical data onto the intermediary server and interacting with editing tools provided by the intermediary server through the application or through an Internet browser or other software application to accomplish the editing.

In some embodiments, the method of the present invention includes a step of uploading to the intermediary server, using the application, the edited graphical data of electronic gameplay, and associating the edited graphical data with the unique user ID. In some embodiments, the uploading is only permitted after the user has created a registered account on the intermediary server having a unique user ID.

In some embodiments, the method of the present invention includes a step of converting, using the application and the intermediary server, the edited graphical data into a cryptographically secured digital asset associated with a unique digital asset ID. In some embodiments, the converting includes securing, and/or associating with the cryptographically secured digital asset, a cryptographic token. In some embodiments, the converting includes associating cryptographic keys with the cryptographically secured digital asset, such as a public and private key pair. In some embodiments, the converting may include linking a cryptographic token to the edited graphical data or a copy thereof. In some embodiments, the converting may include distributing therewith the edited graphical data or a copy thereof. In some embodiments, the converting may include converting the edited graphical data into a different file format or form of data. In some embodiments, the converting may include generation of any form of computer-generated virtual object that has a unique, non-fungible tokenized code (“token”) registered on and validated by a blockchain, other form of distributed ledger, or otherwise registered in a database. In an exemplary embodiment, the token is an Ethereum Request for Comments (ERC) 721 or ERC1155 token. In other embodiments, any token standard appropriate for the creation of non-fungible tokens may be used. In some embodiments, a plurality of cryptographically secured digital assets may be created from a single edited graphical data, each with a unique digital asset ID associated therewith. In some embodiments, the plurality of cryptographically secured digital assets created may all be identical. In other embodiments, the plurality of cryptographically secured digital assets may include multiple subtypes, views, or aspects of a single edited graphical data.

In some embodiments, the method of the present invention includes a step of storing, using the intermediary server, the unique digital asset ID associated with the cryptographically secured digital asset, preferably as a cryptographic token, more preferably also with an associated cryptographic key, such as a public and private key pair.

In some embodiments, the method of the present invention includes a step of transmitting, using the intermediary server, a cryptographic block to a distributed blockchain ledger to record or register creation of the cryptographically secured digital asset, preferably where the cryptographic block includes the unique digital asset ID. Non-limiting examples of appropriate distributed blockchain ledgers for use with the present invention include Bitcoin, Ethereum, Litecoin, and others.

Exemplary embodiments of the creation, management, and transfer of the cryptographically secured digital assets of the present invention may be found in U.S. application Ser. No. 15/388,707, filed Dec. 22, 2016, entitled “Digital Asset Intermediary Electronic Settlement Platform”, the entirety of which is hereby incorporated by reference.

Another embodiment of the present invention provides a method for distribution of a cryptographically secured digital asset, the method including a step of providing an intermediary a server and an application for download to a computing device associated with a user.

In an embodiment, the method of the present invention includes a step of receiving, from a plurality of computing devices each associated with a unique user ID, a first plurality of edited graphical data of electronic gameplay, and storing the first plurality of edited graphical data on the intermediary server. In some embodiments, the first plurality of edited graphical data is created by the user using the provided software in connection with one or more electronic game engines and/or games. In some embodiments, the receiving step may instead include receiving a plurality of unedited graphical data of electronic gameplay. In such embodiments, editing tools are provided to users, using the intermediate server, and either the application or a software browser directed to a designated Internet site, for editing the unedited graphical data into edited graphical data. Further embodiments may include combinations of the features provided above.

In an embodiment, the method of the present invention includes a step of displaying, using the intermediary server, the first plurality of edited graphical data on the Internet. Such listing may take the form of a grid, a slideshow, a list, or any other form of displaying a plurality of images on an Internet site.

In an embodiment, the method of the present invention includes a step of prompting, using the intermediary server, each of a plurality of viewers viewing the first plurality of edited graphical data to provide information indicating approval of one or more of the first plurality of graphical data. Preferably, a display on the Internet site of the first plurality of edited graphical data will include instructions for any viewer of the Internet site to vote for one or more of the first plurality of graphical data. Preferably, the display interface of the first plurality of edited graphical data will contain buttons, widgets, or other interactable website tools that will allow a viewer to enter their vote directly on the Internet site, next to their chosen choice(s). Exemplary embodiments of such display interface will include such features as a button, preferably shaped as an upward pointing arrow, which a viewer may press to register their vote, and a displayed tally of the number of votes for each of the first plurality of edited graphical data. Additional features of such display interface may include filtering tools, with criteria such as electronic game engine, game type, game platform, and game franchise, search tools, and sorting tools, which may, for example, allow viewers to sort the first plurality of edited graphical data by number of votes, date uploaded, recently popularity, and other such metrics.

In an embodiment, the method of the present invention includes a step of storing, using the intermediary server, a tally of the number of viewers indicating approval of each of the first plurality of edited graphical data.

In an embodiment, the method of the present invention includes a step of selecting, using the intermediary server, a second plurality of edited graphical data, wherein the second plurality of edited graphical data is a subset of the first plurality of edited graphical data. In preferred embodiments, the second plurality of edited graphical data is chosen based on the subset of the first plurality of edited graphical data receiving the most votes. In some embodiments, additional factors, such as adherence to a theme, limiting selections to a single submission per unique user, similarity to existing or prior submissions, or other factors, may be used to help determine the second plurality of edited graphical data. In some embodiments, the number of individual selections in the second plurality of edited graphical data is a predetermined number.

In some embodiments, the method of the present invention includes a step of assigning, using the intermediary server, a rating to each of the second plurality of edited graphical data based on the respective tally of votes received by each. In an exemplary embodiment, such ratings represent the rarity of each of the second plurality of edited graphical data, and may include such ratings as “common”, “rare”, and “super rare”. In other embodiments, other forms of indicating rating, including lettering systems, numbering systems, or systems utilizing symbols such as stars may be used.

In some embodiments, the method of the present invention includes a step of determining, using the intermediary server, a number of copies of each of the second plurality of edited graphical data to be converted to cryptographically secured digital assets, preferably where the number of copies is based on the rating assigned to each of the second plurality of edited graphical data. In an exemplary embodiment, the higher the rarity assigned to a given member of the second plurality of edited graphical data, the fewer the number of cryptographically secured digital assets created based on such member.

In some embodiments, the method of the present invention includes a step of converting, using the intermediary server, the number of copies of each of the second plurality of edited graphical data to a plurality of cryptographically secured digital assets, each being associated with a unique digital ID.

In some embodiments, the method of the present invention includes a step of providing for sale, using the intermediary server, the plurality of cryptographically secured digital assets. In some embodiments, such offer for sale may be made on the Internet site on which viewers were previously prompted to vote for one or more of the first plurality of edited graphical data. In some embodiments, such offer for sale may be made through the provided application. In some embodiments, such offer for sale may be made through a separate platform for sale of cryptographically secured digital assets. In some embodiments, such offer for sale may be made through any means of interacting with fans of electronic games, such as directly through game interfaces, through digital gaming marketplaces, through specialized applications, or others. In an exemplary embodiment, an auction model is not used, but instead each week (or bi-weekly), a fixed number of cryptographically secured digital assets will be made available for sale on an Internet site. In such embodiment, prices for cards will be fixed, preferably based upon classification, and more preferably will be sold on a first-come, first serve basis. Preferably, each game for which cryptographically secured digital assets are being made will have a separate selection process and sales process. Preferably, the proceeds of a sale will be divided between the owners of the intermediary server, the user responsible for creating the cryptographically secured digital asset, and the company owning the intellectual property on which the cryptographically secured digital asset is based. In an example of such revenue sharing scheme, 50% of revenues from the sales would be assigned to the owners of the intermediary server, 25% to the user responsible for creating the cryptographically secured digital asset, and 25% to the company owning the intellectual property on which the cryptographically secured digital asset is based.

In some embodiments, the method of the present invention includes a step of transmitting, using the intermediary server, a cryptographic block to a distributed blockchain ledger to record transfer of one of the plurality of cryptographically secured digital assets, when one of the plurality of cryptographically secured digital assets is purchased, preferably where the cryptographic block comprises the unique digital asset ID and a digital ID associated with a purchaser. In an exemplary embodiment, the unique digital asset ID includes one or more of a cryptographic token and a cryptographic key associated with the token and/or cryptographically secured digital asset, and the digital ID associated with a purchaser includes a cryptographic key associated with the purchaser.

In some embodiments, the method of the present invention includes a step of transmitting, for each of the plurality of cryptographically secured digital assets, using the intermediary server, a cryptographic block to a distributed blockchain ledger to record creation of a cryptographically secured asset, wherein the cryptographic block comprises the unique digital asset ID and preferably a digital ID associated with the intermediary server. Such step outlines the traditional minting process of a non-fungible token where, for example, gas fees for an Ethereum blockchain (or other such equivalent transaction costs or requirements) are paid at the moment of creation of a given token for a cryptographically secured digital asset before being offered for sale. In alternate embodiments, so-called “lazy minting” may instead be used, where registration with a blockchain or other distributed ledger is only registered at the time of the first transfer of the cryptographically secured digital asset. In such embodiments, gas fees for such blockchain network or equivalents may instead be paid only by the purchaser of a given cryptographically secured digital asset at the time of sale.

In some embodiments, the cryptographic block further includes a set of instructions, preferably where the set of instructions defines at least one condition and at least one action to be performed on evaluation of the at least one condition. Such instructions built into blockchains are generally known as “smart contracts”, and any method of implementing such smart contracts known in the art may be used here. In an exemplary embodiment, the at least one condition includes resale of the cryptographically secured digital asset to which such cryptographic block is associated, and the at least one action to be performed includes remitting a percentage of the resale value of the cryptographically secured digital asset thus resold to the intermediary server, preferably 10% of the resale value. In some embodiments, such remittance is made to a designated cryptocurrency wallet or wallets.

It is understood that when an element is referred hereinabove as being “on” another element, it can be directly on the other element or intervening elements may be present therebetween. In contrast, when an element is referred to as being “directly on” another element, there are no intervening elements present.

Moreover, any components or materials can be formed from a same, structurally continuous piece or separately fabricated and connected.

It is further understood that, although ordinal terms, such as, “first,” “second,” and “third,” are used herein to describe various elements, components, regions, layers and/or sections, these elements, components, regions, layers and/or sections should not be limited by these terms. These terms are only used to distinguish one element, component, region, layer and/or section from another element, component, region, layer and/or section. Thus, a “first element,” “component,” “region,” “layer” and/or “section” discussed below could be termed a second element, component, region, layer and/or section without departing from the teachings herein.

Features illustrated or described as part of one embodiment can be used with another embodiment and such variations come within the scope of the appended claims and their equivalents.

Spatially relative terms, such as “beneath,” “below,” “lower,” “above,” “upper” and the like, are used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device can be otherwise oriented (rotated 90 degrees or at other orientations) and the spatially relative descriptors used herein interpreted accordingly.

Example embodiments are described herein with reference to cross section illustrations that are schematic illustrations of idealized embodiments. As such, variations from the shapes of the illustrations, for example, of manufacturing techniques and/or tolerances, are to be expected. Thus, example embodiments described herein should not be construed as limited to the particular shapes of regions as illustrated herein, but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

In conclusion, herein is presented a method for creation of a cryptographically secured digital asset, and a method for distribution of a cryptographically secured digital asset. The disclosure is illustrated throughout the written description. It should be understood that numerous variations are possible while adhering to the inventive concept. Such variations are contemplated as being a part of the present disclosure.

What is claimed is:

1. A method of creation of a cryptographically secured digital asset, the method comprising:
a) providing an application configured to communicate with an intermediary server and a video game engine;
b) downloading, on a computing device associated with a user, the application;
c) registering, on the intermediary server, a unique user identification (ID) associated with the computing device;
d) capturing, using the application and the video game engine, a graphical data of electronic gameplay;
e) editing, using the application, the graphical data of electronic gameplay to produce an edited graphical data;
f) uploading to the intermediary server, using the application, the edited graphical data, and associating the edited graphical data with the unique user ID;
g) converting, using the application and the intermediary server, the edited graphical data into a cryptographically secured digital asset associated with a unique digital asset ID; and
h) storing, using the intermediary server, the unique digital asset ID associated with the cryptographically secured digital asset.

2. The method of claim 1, further comprising step (i) transmitting, using the intermediary server, a cryptographic block to a distributed blockchain ledger to record creation of the cryptographically secured digital asset, the cryptographic block comprising the unique digital asset ID.

3. A method of distribution of a cryptographically secured digital asset, the method comprising:
a) providing an intermediary server and an application for download to a computing device associated with a user;
b) receiving, from a plurality of computing devices each associated with a unique user ID, a first plurality of edited graphical data of electronic gameplay, and storing the first plurality of edited graphical data on the intermediary server;
c) displaying, using the intermediary server, the first plurality of edited graphical data on the Internet;
d) prompting, using the intermediary server, each of a plurality of viewers viewing the first plurality of edited graphical data to provide information indicating approval of one or more of the first plurality of graphical data;
e) storing, using the intermediary server, a tally of the number of viewers indicating approval of each of the first plurality of edited graphical data;
f) selecting, using the intermediary server, a second plurality of edited graphical data, wherein the second plurality of edited graphical data is a subset of the first plurality of edited graphical data;
g) assigning, using the intermediary server, a rating to each of the second plurality of edited graphical data based on the tally stored in step (e);
h) determining, using the intermediary server, a number of copies of each of the second plurality of edited graphical data to be converted to cryptographically secured digital assets, wherein the number of copies is based on the rating assigned in step (g);
i) converting, using the intermediary server, the number of copies of each of the second plurality of edited graphical data determined in step (h) to a plurality of cryptographically secured digital assets, the plurality of cryptographically secured digital assets each being associated with a unique digital asset ID;
j) providing for sale, using the intermediary server, the plurality of cryptographically secured digital assets; and
k) transmitting, using the intermediary server, a cryptographic block to a distributed blockchain ledger to record transfer of one of the plurality of cryptographically secured digital assets, when one of the plurality of cryptographically secured digital assets is purchased, wherein the cryptographic block comprises the unique digital asset ID and a digital ID associated with a purchaser.

4. The method of claim 3, wherein step (i) further comprises transmitting, for each of the plurality of cryptographically secured digital assets, using the intermediary server, a cryptographic block to a distributed blockchain ledger to record creation of a cryptographically secured asset, wherein the cryptographic block comprises the unique digital asset ID and a digital ID associated with the intermediary server.

5. The method of claim 3, wherein the cryptographic block further comprises a set of instructions, wherein the set of instructions defines at least one condition and at least one action to be performed on evaluation of the at least one condition.

6. The method of claim 5, wherein the at least one condition comprises a resale of the cryptographically secured digital asset associated with the unique digital asset ID recorded in the cryptographic block, and the at least one action comprises remitting 10% of a resale price of the cryptographically secured digital asset associated with the unique digital asset ID recorded in the cryptographic block to the intermediary server.

7. A non-transitory computer readable storage medium, comprising storage, retrieval, modification, and linking system software which instructs at least one computer processor residing on a specialized computer system to implement a process to: download an application configured to communicate with an intermediary server and a video game engine; register, on the intermediary server, a unique user identification (ID) associated with the specialized computer system; capture, using the application and the video game engine, a graphical data of electronic gameplay; edit, using the application, the graphical data of electronic gameplay to produce an edited graphical data; upload to the intermediary server, using the application, the edited graphical data, and associate the edited graphical data with the unique user ID; convert, using the application and the intermediary server, the edited graphical data into a cryptographically secured digital asset associated with a unique digital asset ID; and store, using the intermediary server, the unique digital asset ID associated with the cryptographically secured digital asset.
